(19) United States
(12) Patent Application Publication
(10) Pub. No.: US 2011/0215511 A1
(43) Pub. Date: Sep. 8, 2011

(54) MACHINE TOOL

(76) Inventor: Burkhart Grob, Bad Worishofen (DE)

(21) Appl. No.: 13/037,433

(22) Filed: Mar. 1, 2011

(30) Foreign Application Priority Data
Mar. 2, 2010 (DE) 10 2010 009 947.3
Sep. 8, 2010 (DE) 10 2010 044 783.8

(51) Int. Cl. B23Q 3/02

(52) U.S. Cl. 269/134

(57) ABSTRACT

The invention refers to a machine tool for machining one or more work pieces, wherein the work piece is held indirectly or directly by a clamping device in the machine tool on or at a non-rotary work piece table or a work piece table rotating around at least one axis.

The invention is characterized in that the clamping device comprises at least one clamping element interacting indirectly or directly with the work piece, and an electric motor is provided for generating the clamping power that is in active connection with the clamping element.

### BACKGROUND OF THE INVENTION

The invention refers to a machine tool for the machining of one or more work pieces, wherein the work piece is held indirectly or directly in the machine tool on or in a non-rotatable work piece table or a work piece table in particular rotatable around one axis.

The invention comprises furthermore also a machine tool for the machining of one or more work pieces with a non-rotatable machining tool or in particular by a machining tool driven rotary by a tool spindle, wherein the machining tool is held in a tool mounting indirectly or directly by a tool clamping device.

The machine tools of this kind are, for example, part of more complex, in particular metal cutting machining lines, or also realized in preferably flexibly used machining centers. The machine tools of this kind have, as a rule, a high rotational speed of the metal-cutting machining tools. Also the other forces occurring during machining are actually considerable, so that for an exact machining of the work piece a reliable, exactly positioned fixing of the work piece to be clamped is required. The fixing is done here by a clamping device that has to deviate the considerable machining forces securely.

It is known here to attach the work piece either indirectly or directly to the work piece table or elements of the work piece table; a clamping device serves for that. When the work piece is attached directly, the clamping device acts directly on the work piece, when the attachment is indirect, the work piece is clamped, for example, on a work piece carrier or a pallet, and the clamping device interacts in a suitable way with the work piece carrier or the pallet. A clamping device for the work piece therefore requires, on the one hand, a positioning as exact as possible, on the other hand, a stability as high as possible, that is a high clamping power, to secure an exact machining with as few rejects as possible.

The same, however, is required for the machining tool clamped in the tool mounting of the machine tool.

It is known in the state of the art to hold or clamp the work piece to be machined (indirectly or directly) as well as also the machining tool for the machining (indirectly or directly) by hydraulic means.

Hydraulic clamping means have the advantage of developing high forces in a rather small space.

However, it is a disadvantage that installing the hydraulic lines that have to withstand a rather high pressure (several 100 bars) is expensive The hydraulic lines also require, because of the high stress, appropriate maintenance. The work piece table can be positioned for machining purposes in the space along at least one spatial axis, as a rule along several spatial axes. Therefore, the hydraulic line must be sufficiently flexible to be able to follow these motions in the space. However, often the work piece table can also rotate in the space, and also in these swiveled positions a reliable hydraulic supply has to be guaranteed what can be reached with these mentioned rotatable elements only with a considerable effort for construction as well as for maintenance.

Alternatively, the use of pneumatic work piece clamping systems is known, however, these do not reach such high holding forces.

There is also the problem that position interrogations, for example is the work piece clamped or the machining tool clamped, can only be interrogated indirectly via the pressure or other expensive installations.

Eventually, also the effort for apparatus for installing the hydraulic arrangement is considerable, as besides a piping and installation of fitting hoses or flexible pipes also an appropriate pump aggregate as well as valves and selecting of the valves are required.

Coming from this state of the art it is an object of the invention to suggest an improvement for the clamping of one or more work piece(s) in machine tools, in particular metal-cutting machine tools.

### BRIEF ABSTRACT OF THE INVENTION

In order to solve this problem the invention refers to a machine tool as described in the beginning, and suggests that on the work piece table an electric motor is provided the generated power, engine torque and/or moment of momentum of which acts indirectly or directly on the work piece. Instead of a hydraulic or pneumatic drive now an electric motor is employed that operates the clamping device, or the electric motor interacts with a clamping element of the clamping device. However, the knack is not only limited to the clamping of a work piece, but it can be used in the same way also for a tool clamping device. The tool clamping device comprises here at least one tool clamping element interacting indirectly or directly with the machining tool, and an electric motor is provided for generating the clamping power that is in active connection with the tool clamping element.

The suggestion allows, if necessary, to ban the complete hydraulic system from the machine tool. The suggestion makes it in particular possible to use electric lines that can be handled much easier and that have to be guided in the also longitudinally moving or rotary designed work piece tables what can be realized much easier by appropriate media lines, trailing cable devices and so on.

Basically, the suggested machine tool, however, still provides the chance of realizing in special applications, nevertheless, a hydraulic clamping of the work piece (indirectly or directly) or the machining tool (indirectly or directly). Instead of providing a central hydraulic aggregate, locally, for example in the tool mounting or on the work piece table or the clamping element(s), an appropriate hydraulic pump is operated by the electric motor that provides than in a suitable way the hydraulic acting clamping elements with the hydraulic medium for an appropriate pressure level.

It is a considerable advantage of the suggested machine tool that it can be employed in this area very flexible, and the electric motor provides a universal source of power that is able to transmit via known mechanical components, such as gear, chains, pinion arrangement, toothed wheels, angular gear and so on, power and turning moment to the respectively required places. However, it is also possible to drive through the electric motor, for example, a hydraulic pump or pneumatic pump or other elements, and to use these sources of power and energy, respectively, then in a suitable way in the machine tool.

Surprisingly, the concept does not only offer a considerable improvement of the clamping device, but enlarges considerably the field of use of a machine tool according to the invention. Through the suggestion the clamping process is improved considerably. Thus it is suggested that the clamping device comprises at least one clamping element interacting indirectly or directly with the work piece, and an electric motor is provided for generating the clamping power that is in active connection with the clamping element. The use of the electric motor in the work piece table, however, also allows a permanent rotation of the work piece. Thus, with a low effort the machine tool can be reset, and the electric motor serves then on the work piece table a rotational drive for the work piece, for example, for providing rotary grinding or turning on a lathe machining on the work piece. For that, then the machining tool is clamped stationary, for example, in an otherwise rotating tool spindle, and angled towards the work piece like in a turning lathe.

The following advantages occur with an arrangement, in the following also described as a mechatronical clamping device.

A machine equipped in this way has basically a high availability as it cannot only be used for conventional boring or milling machinings but also turning on a lathe machinings are possible with it.

The initiation of the clamping device is fast in combination with a feeding device.

The turning connections or turning distributions known in the state of the art for the hydraulic or pneumatic lines are avoided completely by the suggestion. There is no wear of moved seals, turning and positioning of the work piece table is simpler and can be carried out with lower power.

Basically, the machine tool allows a fast reset of the machine to other work pieces and also other machining processes.

The suggested machine tool makes it possible to realize a control of the clamping power across the motor current consumed by the electric motor.

Leakage in the hydraulic system is avoided, and also the effort for maintenance for tightening the hydraulic screwing and so on is dropped. As no other hydraulic hoses have to be installed anymore, the hydraulic hoses do not need to be exchanged in regular exchange intervals, either. Also the rather high effort for deep hole borings in the basic slab of the device provided for receiving the hydraulic lines is dropped.

As in the work piece table a preferably rotating clamping drive is provided very different clamping devices can be employed. It is, for example, possible to arrange single clamping elements, or to realize the clamping device as vise with three or multiple jaw chuck. Also a top spindle or the like can be used.

The suggested machine tool improves the environmental compatibility, as hydraulic oil is not required. Also a higher efficiency of energy is achieved.

According to a preferred modification it is provided that the electric motor, preferably as central drive, drives several clamping elements via the at least one means for power transmission. In this modification, then the electric motor is arranged, for example, below the clamping plane, and one means for power transmission is able to drive several clamping elements at the same time. The effort here for the electric motor and its cabling is rather low, however, it is more difficult to realize individual solutions with respect to the clamping power.

According to this, another modification suggests that for each of the clamping elements one electric motor as driving means for generating the clamping power is provided. The single motors can now be controlled also with different forces or moments. Also the constructive size of the single electric motor can be lower than, for example, with one electric motor as central drive. However, both modifications are comprised by the invention, and solve the problem perfectly, and thus contribute to the above described positive effects.

The efficiency of the machine tool is increased by using instead of expensive hydraulic components one or more electric motor(s) as drive(s), in particular as indirect or direct clamping or rotary drive(s).

It is seen here as favorable, if as drive an electric motor, in particular a servo motor, is used. This electric motor or servo motor can be designed, in particular, as synchronous, asynchronous or direct current motor. It is advantageous, if a servo motor is used, that its construction is compact, sturdy and that there is the possibility of a closed control circuit. The operation can be here moment controlled, speed controlled or position controlled.

It is seen as a favorable development when the drive is carried out via a sensorless synchronous or asynchronous motor. A permanent magnet excited synchronous motor (PMSM) is in particular preferred here. The suggestion comprises here in the same way the arrangement of the permanent magnet(s) as buried magnet(s) or as surface magnet(s) on the rotor, wherein the use of buried magnet(s) in the rotor is seen as particularly advantageous as mechanic stress occur in the bundle of laminations of the rotor and not on the surface. Additionally the loss is lower in the permanent magnet.

The use of permanent magnets on or in the rotor makes the excitation winding otherwise present in synchronous machines unnecessary.

It is seen as an advantage when sensorless motors are used, in particular synchronous motors, that here the additional arrangement of sensors or transmitters for the position definition of the rotor can be dropped, and the size of the construction is accordingly reduced. In the machine tools according to the invention or in the tool clamping devices or work piece clamping devices or turning on a lathe devices provided in them the constructional space for the single components is narrow so that to a structure of the machining center as compact as possible has to be realized. Besides the increasing of the efficiency of the dynamic of conventional machine tools, the constructive size or the requirements of constructive size can be perfected through the use of sensorless motors with respect to the drive.

In an embodiment of the machine tool seen as favorable a sensorless definition of the rotor position, in particular a sensorless recognition of the standstill position is provided that can be realized in particular through the sensorless synchronous motor. Thus, in a sensorless synchronous motor, for example, the position of the rotor can be estimated by means of an anisotropy of the resulting inductance in the used stator coils of the stator. During the operation of the synchronous motor, depending on the rotor position in the stator coils, different resulting inductivities can be measured through which the position of the rotor can be estimated. It is seen as advantageous in this connection when the definition of the rotor position or the recognition of the standstill position can be carried out software- of NC-controlled. An appropriate integration in the machine control, for example a machine control comprising a micro controller, can be realized in a simple manner.

A preferred possibility for defining the rotor position or the standstill position provides for example that measuring signals are superimposed to the select signal for connecting the stator currents for the stator coils in such a way that additionally to the driving magnetic field an alternating magnetic field is generated, wherein the current flows caused by the multi signals depend through the stator coils on the rotor position-depending, resulting inductance of the synchronous motor. The resulting inductance of the synchronous motor depends on the position of the rotor. The process for a sensorless definition of the rotor position is based here on the detection of the magnetic anisotropy of series and shunt inductance of the motor. If a fast alternating voltage is connected to the motor, the voltage in the pillar lane almost completely drops on the rotor position-depending inductance. The excited current is thus modulated by the rotor position, and can be evaluated accordingly. The strength of the signal is proportional to the difference of series and shunt inductance.

The input and output signals are processed by a control or measuring software or the NC-control, to define thus the rotor position or the standstill position. This again defines the tool application position or the work piece machining position or the position of the clamping element or clamping device for the work piece driven by an electric motor of this kind. If necessary, in the machine control a separate switching circuit or a micro controller programmed for it is provided for evaluating the rotor position.

The use of synchronous motors has other advantages besides the reduction of the constructive space required for the drive. Thus, the costs for installation are reduced altogether as sensor line, sensor and sensor interface are not required. The synchronous motors make a high dynamic and a slip-free motion possible. Besides the reduced space requirement, they also have a low weight, however, a high efficiency and a high flexibility. The position definition can be integrated in a simple way in the machine control of the machine tool according to the invention, resetting or retrofitting of existing machines is possible.

Another aspect of the machine tool is given by the fact that the electric motor is monitored by a control, preferably the control of the machine tool as NC-axis, wherein the control recognizes or derives because of these data the exact position or the exact location of the clamping element, and/or the control recognizes because of the determined data or because of the determined moment the imprinted or entered power of the clamping element(s). This modification of the invention is an advantage in the respect that now it is possible—in contrast to the so far expensive control installations for checking the corresponding position or the entered turning moments or the power—because of the monitoring of the NC axis or the electric motor and its parameters with reference to the energy consumption, to provide the required data in a simple way, and this is in the desired resolutions with respect to the single clamping elements. Through this also the effort of control and monitoring technology of a machine tool of this type can be reduced considerably by the use of an electric motor in connection with the control. Furthermore, the determined data are associated exactly with the single clamping elements what makes altogether a more favorable selection, if necessary, of the single elements possible.

It is an advantage when as means for power transmission, such as, for example, a timing belt, a chain or a gear is provided transmitting the power generated by the electric motor or the generated turning moment to the clamping elements or the clamping device. It is an advantage here, if, for example, a chain is guided from the electric motor to the clamping means over a pinion to transmit the forces there. The imprint of the power can then be determined either to the clamping means itself by elements integrated there or by directly imprinted power via the electric motor.

A solution is also provided where the electric motor is arranged on a motor shaft connecting piece on the clamping device or on the clamping means on the same axis of symmetry or parallel to it. Of course, also a modification is comprised where the electric motor is arranged angular, preferred rectangular, to the axis of symmetry of the clamping device or the clamping means.

Furthermore it is provided that the clamping means has a free wheel, a clutch, designed preferably as sliding clutch, or the like to limit the power to be transmitted. Here, for example, the free wheel or the clutch as sliding clutch can be set in such a way that each clamping means imprints different forces or even identical forces. Of course, it is also possible to provide in the clamping means, for example, a spring or a spring assembly that generally acts in such a way that the necessary clamping power is generated. The electric motor then acts in interaction with the free wheel or the clutch in such a way that these are only used for releasing the work piece after finishing the machining, and imprint the necessary forces to move the spring assembly or the spring then in a lifted position. The same is, of course, also possible when instead of a spring a hydraulic cylinder is provided there that is arranged directly on or in the clamping means. This modification, however, will be discussed later on.

At least one clamping claw serving for clamping the work piece is provided on the clamping means. The clamping claw has the purpose to engage on the work piece or on the tool in such a way that a certain positive locking connection exists, for example by appropriate recesses or grooves or channels on the work piece or the machining tool in which the clamping claw can engage. The pressure then pushes the work piece or the tool either on the machining table or in or on the tool mounting.

As already mentioned it is an advantage that at or in the clamping element, preferably in the clamping means a pressure-generating element, such as, for example, a pressure spring or a spring assembly is provided that in uncoupled state presses or moves the clamping claw in the clamping position, and in coupled state the electric motor moves the clamping claw in its initial or rest position. The initial or rest position is here the position in which the work piece can be removed.

According to a modification of the machine tool it is furthermore provided that at or in the clamping means a pull-back element, such as, for example, a tension spring is provided that moves the clamping claw in uncoupled or not clamped state in an initial position. This is the reverse solution of the before described modification where the pressure spring or a spring assembly pressurizes the clamping claw during the clamping process, and the clamping claw has been moved back in an initial position by the power of the electric motor only for releasing. The now described modification shows the exactly reversed way, namely, for example, to load the pressure spring with tension while the clamping claw clamps the work piece, and then in uncoupled state the tension spring returns the clamping claw in the initial position.

It has been found to be an advantage when the clamping claw has a nose-like designed clamping lug arranged in the direction of clamping facing the clamping plane angled, deviating 1° to 5°, preferably 2°, from the parallel to the clamping plane. This tilts the clamping claw or the clamping lug slightly in the direction of the work piece what improves the clamping process and makes the engagement of the clamping claw on the work piece easier, respectively. With reference to the axis of symmetry of the clamping element the clamping lug is at an angle of about 90° to this axis of symmetry with the already described deviation of 1° to 5°, or preferably 2°, then deviating from the 90°-plane facing in the direction of the work piece.

It is also an advantage when the clamping claw can move essentially to the clamping claw. Thus, only an appropriate recess or groove where the clamping claw can engage has to be provided on the work piece or the work piece carrier carrying the work piece.

A development of the machine tool provides that the clamping element is designed as collet chuck. Collet chucks are preferably always used when, for example, certain clamping means such as clamping bolts or the like are arranged, for example, on the pallet carrying the work piece or on the work piece itself so that the collet chuck can embrace these clamping means. The solution with reference to the electric motor as drive for the clamping means can also be used in this modification.

Another convenient embodiment suggests that the clamping element is designed like a truncated cone and has a mounting in which a pin arranged in a pallet carrying the work piece or at the work piece to be machined is inserted for the clamping process. In up-to-date machining centers, where the machine tool can be employed, usually the pallets carrying the work piece are provided with these pins. In this case then the clamping element is designed correspondingly with this pins to embrace them and clamp for the machining process. A development of this suggests here, that the mounting is embraced by a collet chuck that presses preferably the clamping clasps in clamped state against or towards the pin. This is an advantageous development that designs the entire clamping process even more efficiently.

It is also an advantage when the pin as clamping means has a pin head. Preferably this pin head is formed in the pin. This pin head can be designed here at least partly ball-like or hemisphere-like or have appropriate curves or chamfers.

It is suggested, that the means for power transmission driven by the electric motor engages on the collet chuck. This can be, for example, an angular gear, a chain drive with chain and pinion or a timing belt with an appropriately designed pinion.

A favorable modification also provides that the clamping elements and/or the collet chucks are designed hydraulically acting, wherein the pressure-generating hydraulic pump is provided directly at or in the clamping element or at or in the collet chuck. In the beginning, the advantage of such a solution has already been described as it is not necessary in such a design to supply the expensive hydraulic aggregates or to connect them by pipes or hoses. According to the solution the electric motor drives a hydraulic pump generating pressure that is arranged directly in or at the clamping element. Thus, only a connection from the hydraulic pump, if necessary, to the pressure cylinder, at the clamping means has to be produced that can be provided directly as boring in the clamping element or in the collet chuck. Thus quasi the hydraulic element is installed in the last possible element during the clamping process, namely in the collet chuck or in the clamping means itself. The expensive piping and/or providing of suitable hose connections, distributors and the like is dropped completely. It is not necessary here, either, to provide suitable, flexible elements that have to compensate swiveling of the machining plane. Nevertheless, the hydraulic system provides, as a rule, slightly higher pressure for clamping the work pieces.

According to this the solution achieves that at or in the clamping element a hydraulic pump is provided acting independently from a central hydraulic aggregate and generating directly at or in the clamping element the required contact pressure for clamping the work pieces or the tools. This is an advantageous solution because—as already mentioned—the high contact pressure can be generated directly in or at the clamping element.

It is seen as favorable to provide a control for the clamping power through which the exact clamping of the work piece is monitored. It is also possible here to enter or supply different clamping forces at different clamping elements. This is also achieved through the clamping power control. Furthermore, it is, of course, also possible because of the clamping power control, to determine the exact clamping of the work piece to be machined or the machining tool.

Up-to-date machining centers and machine tools work with a so-called zero point clamping device. Generally, here certain points of the article to be clamped are set to get an exact positioning or orientation of the work piece at or on the machining surface. Accordingly, an advantageous development of the machine tool is characterized in that this zero point clamping device is provided for an exact positioning or orientation of the work piece at or on the machining surface. Of course, the corresponding means also have to be provided on the respective work piece. During positioning or orientation of the work piece, because of these additional means, it is then recognized whether the work piece to be machined is positioned correctly. If it is, for example, not positioned correctly, for example, because of the control devices for the clamping control it can be checked whether all clamping means have exactly the required tension. If this is not the case, the result will be that releasing and positioning have to be carried out one more time, before the clamping process is repeated again. It is also an advantage, if on the clamping means or in its immediate vicinity and/or on the machining surface or the clamping surface at least one reference surface is provided for determining and/or testing the exact positioning of the work piece or the pallet carrying the work piece. Determining the exact positioning and, if necessary, readjusting the clamping process can be accomplished with slightly less effort by the reference surface than described before.

Furthermore it is an advantage here if on the work piece and/or on the clamping surface at least one clamping nipple is provided serving, on the one hand, for positioning the work piece on the clamping surface, however, also serving at the same time for clamping the work piece on the clamping surface additionally or alternatively. Of course, there is now the chance, because of the clamping nipples, of determining their position, whether the work piece to be machined is positioned just exactly, what is very decisive for the accuracy of machining. It is another advantage here when at or in the clamping nipple at least one identification means with information about the work piece and/or machining of the work piece, such as, for example, a data carrier, transponder or bar code is provided. Here a sort of a multiple use is provided by the fact that, on the one hand, through the clamping nipples, of course, the exact positioning can be carried out, on the other hand, at the same time information is available whether the work piece to be machined is the correct one that is required for machining right now, and, in particular, also information about the machining of the work piece is available that then can be used for machining. Accordingly, here a very clever modification is provided that increases the effects of the invention considerably.

This data carrier can be arranged here additionally or alternatively, for example, with a separate fastening means on the clamping nipple. As fastening means here a screw can be used as well as the usual gluing or providing of appropriate grooved pins fastening the identification means or the data carrier.

A modification provides that the motor shaft driven by the electric motor has an adapter fitting serving for the optional connection of the motor shaft with a means for the transmission of power for the clamping element(s), or for the connection of the motor shaft with a lathe chuck that serves for the indirect or direct receiving of the work piece for rotary grinding or turning on a lathe machinings on the work piece.

Thus, the electric motor is designed stationary in the work piece table, if necessary, also integrated in the circular table. In this design the electric motor performs its function as clamping drive for the clamping elements of the clamping device even if the work piece is turned around a machining axis (rectangular to the clamping surface) clamped on the work piece table. The supporting plate carrying the clamping elements is designed in such a way, that its position can be defined exactly on the work piece table, but in a very simple way also can be dismantled to remove at the same time also the clamping device carried on the supporting plate. As the electric motor remains stationary, an adapter fitting is provided as coupling that is then released when the supporting plate is lifted. For example, a lathe chuck can then be mounted on the adapter fitting to receive the work piece and to supply it for a rotary grinding or turning on a lathe machining.

The suggested machine tool offers the opportunity of not only positioning the work piece around a rotational axis, such as on a circular table, but to set it also in rotation to make so a machining possible.

The rotary grinding or turning on a lathe machining comprises here circumferential as well as inside or front machining on the work piece.

### BRIEF DESCRIPTION OF THE DIFFERENT VIEWS OF THE DRAWINGS

In the drawing the invention is shown in particular schematically in an embodiment. In the figures:

FIG. 1 a side view of the machine tool according to the invention,

FIGS. 2a, 2b each in a three-dimensional view (FIG. 2a top view, FIG. 2b bottom view) the supporting plate of the machine tool according to the invention,

FIGS. 3, 4, 6, 7 each in a view different embodiments of the clamping element according to the invention,

FIG. 5 in a side view a detail of the electric motor of the machine tool according to the invention,

FIG. 8 a side view of another modification of the machine tool according to the invention with zero point tension,

FIG. 9 detail from FIG. 8.

In the figures identical or corresponding elements each are indicated by the same reference numbers, and therefore are, if not useful, not described anew.

### DETAILED DESCRIPTION OF THE PREFERRED EMBODIMENT

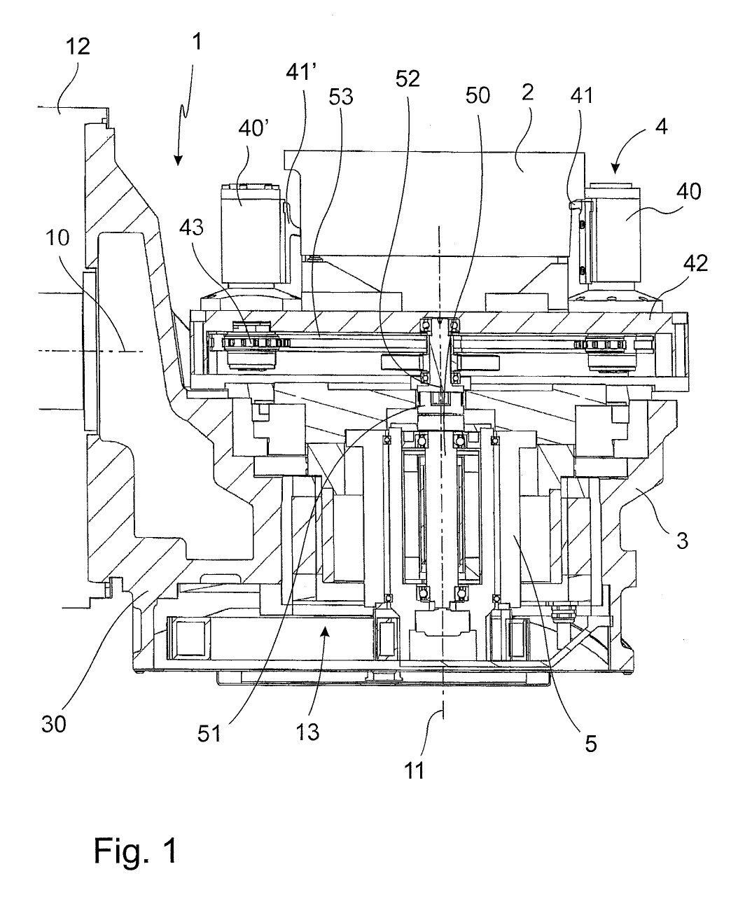

FIG. 1 shows the invention schematically. The machine tool 1 comprises, on the one hand, a work piece table 3, holding the work piece 2. FIG. 1 does not show the machining tool designed, for example, as drill or milling cutter, driven by a tool spindle and moving in an appropriate way relatively to the work piece 2. The machine tool 1 according to the invention has a number of axes. For a machining as flexible as possible it is provided that the work piece 2 can be positioned relatively to the machining tool along the three spatial axes. Besides these longitudinal axes, however, also rotational axes are provided. A first rotational axis is indicated by reference number 10 and is called B-axis. It makes a rotation of the work piece table 3 around a horizontally orientated rotational axis 10 possible. The arrangement is here chosen in such a way that the work piece table 3 has a console 30 arranged, for example, on one side on a slide or pillar 12. If the design is slide-like, for example, a motion in vertical direction (rectangular to the axis 10) is possible.

Furthermore, it is provided that the work piece 2 can rotate around another rotational axis 11, orientated vertically in FIG. 1. As the orientation of this rotational axis depends on the position of the console 30 around the rotational axis 10, of course, the second rotational axis 11 (called, for example, A-axis) is not determined, however, it is rectangular to the first axis 10.

For rotating the work piece 2 around the second axis 11 on the machine tool 1 a preferably electrically designed rotational drive 13 is provided.

It is pointed out, that the design according to the invention can be realized with machine tools 1 that are equipped, as shown, with a rotational function of the work piece table 3 around different spatial axes 10, 11, as well as also with machine tools that do not have such a rotational function, that is, for example, they can only move, for example, along the longitudinal axes or be fixed completely, that means stationary.

In this respect the invention is free in the division of the different motion or rotational axes to the positioning of the work piece or the machining tool.

Instead of the console-like (30) design of the work piece table 3 shown here, of course, also a portal-like design is possible.

The work piece 2 to be machined is clamped on a supporting plate 42, that is part of the work piece table 3, by means of the clamping device 4.

The design of the invention shown in FIG. 1 is chosen in such a way that the clamping device 4 comprises several clamping elements 40, 40′. The single clamping elements 40, 40′ are basically designed identically, and have a laterally projecting clamping claw 41, 41′ provided longitudinally moving on the clamping element. The clamping claw 41, 41′ engages on the appropriate positions on the work piece, and presses it on the supporting plate 42. Besides this direct connection, it is, of course, also possible that the clamping claw holds the work piece indirectly, for example, when the work piece 2 is attached to a work piece carrier or pallet or the like.

The clamping claw 41 is longitudinally moving, rectangular to the plane of the supporting plate 42. This longitudinal movement is realized by a spindle drive 40 where the clamping claw 41 is part of a spindle nut running on a driven spindle. Coaxially to this spindle a toothed wheel 43 is provided that is connected via a chain or another means 53 for power transmission with a central drive. The design is here chosen such that all clamping elements are driven in the same way by the central drive, and an endlessly revolving chain 53 is provided as means for power transmission.

According to the invention, as central drive an electric motor 5 is provided equipped with an appropriate driving pinion and/or a gear, and thus drives the chain or another means 53 for power transmission.

It is convenient here, that, by reversing the rotational direction of the electric motor, the opening and closing motion of the claw 41, 41′ can be influenced.

The construction of the electric motor 5 is standard, a motor shaft projecting from the housing of the electric motor 5 acts as rotor, and carries appropriate elements for the transmission of the turning moment, moment of momentum or power, such as, for example, a pinion, driving pinion, gear or the like.

In the example shown here, an electric motor 5 is provided as central drive acting on several clamping elements 40, 40′. In an alternative concept according to the invention, however, it is also provided that each single clamping element has a direct drive, and thus each single clamping element is associated with its electric motor.

A central part of the invention here is the use of an electric motor in the immediate vicinity of the work piece 2. The motor shaft 50 driven by the electric motor 5 acts here as directly as possible, for example via the motor shaft itself, via a gear, another means for power transmission or via a hydraulic line on the clamping element, and imprints appropriate clamping power in this in such a way, that the wok piece is held reliably.

Between the spindle in the clamping element 40 and the chain drive a sliding clutch is provided in which the clamping power of the clamping element can be limited. The clamping power is here maintained by a self-locking gear, a self-locking motor or another brake.

Through monitoring the current consumption of the electric motor, it is now possible here to monitor cleverly and singly the single clamping states of the clamping elements 40.

Also a free wheel is provided on the claw drives by means of the spindles and the pinions, to reach a releasing of the clamping elements.

Cleverly, between the electric motor 5 and the single clamping elements 40, 40′ of the clamping device 4 also a gear is provided that allows a translation of the increase of the turning moment.

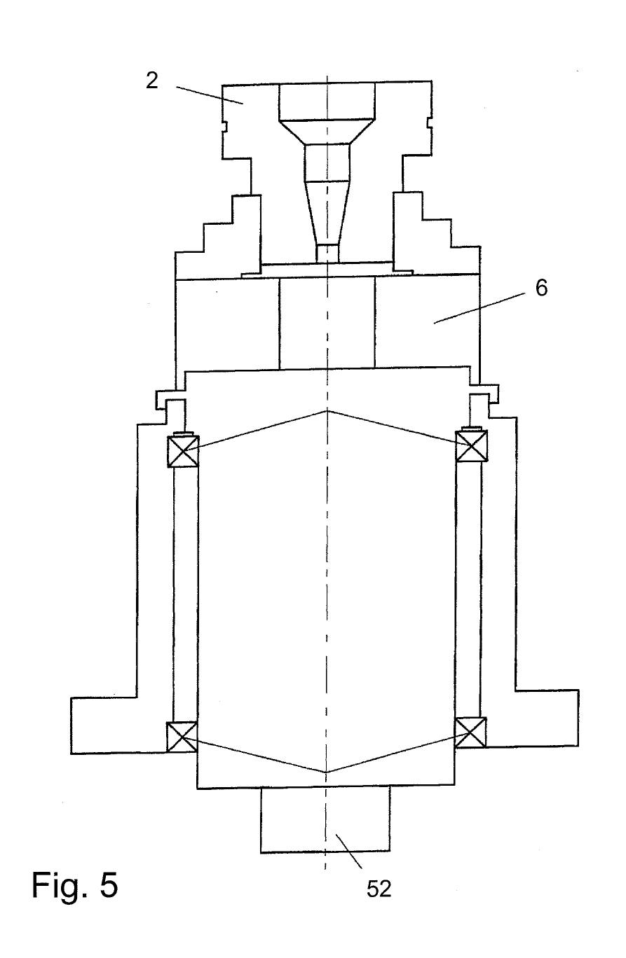

It is also an essential advantage of the invention, that on the motor shaft 50 an adapter fitting 51 is provided, and the entire supporting plate 42 can be removed in a single way from the work piece table 3, and thus in the adapter fitting 51, for example, a lathe chuck can be inserted in which then another work piece 2 can be clamped. Thus, in a short period of time the machine tool according to the invention can be reset from a drilling machining to a turning on a lathe machining. The example for a corresponding lathe chuck is shown in FIG. 5.

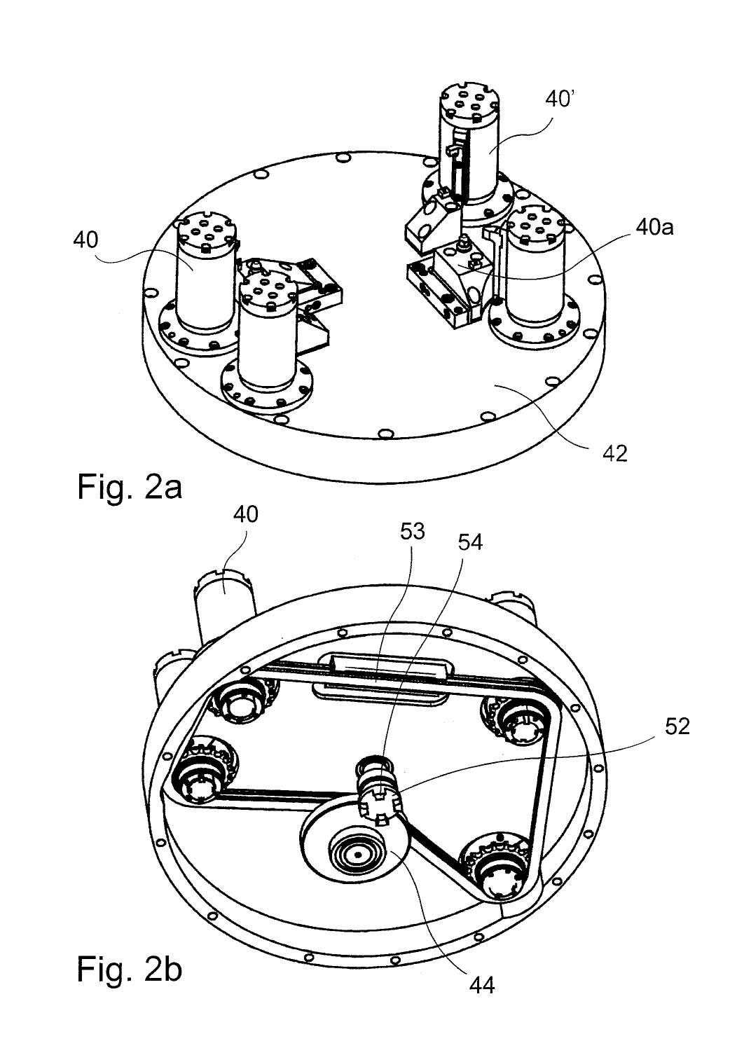

FIGS. 2a, 2b show the supporting plate 42 in a top view (FIG. 2a) and a bottom view (FIG. 2b). On the underside of the supporting plate 42 the connecting piece 52 for the motor shaft can be seen. It has several lateral catches 54 engaging in the corresponding recess of the adapter fitting 51 of the motor shaft (see FIG. 1), and thus transmit the turning moment.

The rotation of the motor shaft 50 sets also the pivoted supported connecting piece 52 of the motor shaft in rotation.

The connecting piece 52 for the motor shaft then drives directly or, if necessary, via a gear a means 53 for power transmission, here, for example, a chain or a roller chain. This chain 53 is guided over the toothed wheels of the single clamping elements 40, and drives it in the same direction. Additionally, the connecting piece 52 for the motor shaft also drives a drive wheel 44 of another, differently designed clamping element 40a. This may be, for example, a so-called zero point clamping device that carries out an exact positioning of the work piece or the work piece carrier/pallet carrying the work piece. It has been mentioned, that as a means 53 for power transmission not only mechanically acting elements are provided, but also again a hydraulically driven clamping device is provided. This does not contradict in any way the idea of the invention! As it can be seen clearly in FIG. 2b, the clamping element 40a driven hydraulically, is on the same rotational plane as the work piece, that means these two elements are not anymore twisted against each other, a rotary division system, that has to be sealed expensively, is not necessary here, the hydraulic piping is rather simple. On the other hand, the design of a zero point clamping device as component is standardized and equipped with an hydraulic impingement function. It is an advantage of the invention, that through the electric motor 5 suggested according to the invention also a (small) hydraulic pump can be driven that then is provided and employed for the hydraulically driven clamping element 40a as zero point clamping device. The driving wheel 44 acts here in a suitable way on this small hydraulic pump.

It must be also mentioned that by a clever guiding of the claw in the clamping element, for example in a connecting link guide, the claw can also carry out a rotary motion. The machine tool according to the invention is often loaded and unloaded automatically, and the claw has then to be removed at the same time out of the motion space of the work piece to be fed or removed. Monitoring the rotating motions of the electric motor therefore also monitors the position of the single clamping claws 41, and, because of the restricted guidance, an arrangement of this type is also operationally reliable.

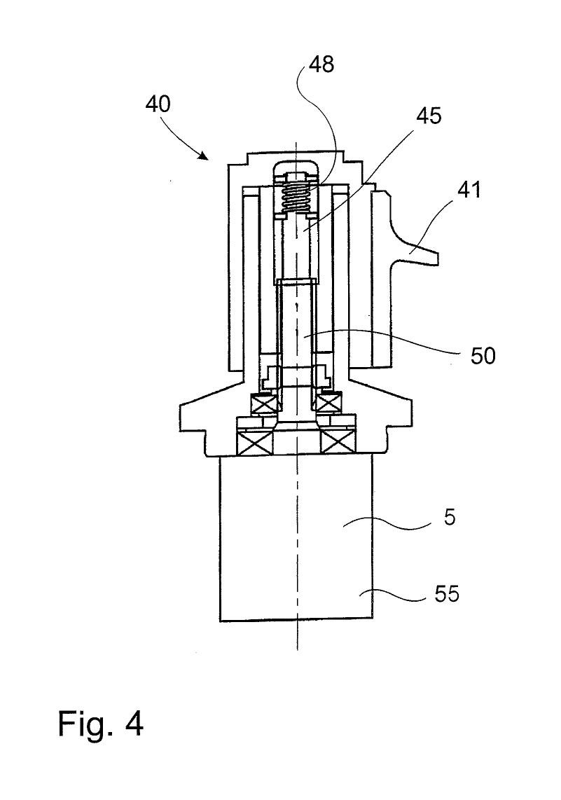

FIG. 4 shows an exemplary construction of a clamping element 40 where an electric motor 5 is connected as direct drive 55. The motor shaft 50 directly drives the spindle 45 of the clamping element 40, the claw 41 is located above a spindle nut on the spindle 45. A tension spring 48 moves the clamping claw 41 in uncoupled or not clamped state in a start position. In a modification not shown, however described before, the spring as pressure spring is compressed in coupled state, so that the clamping claw 41 is moved in the not clamping or non-active position.

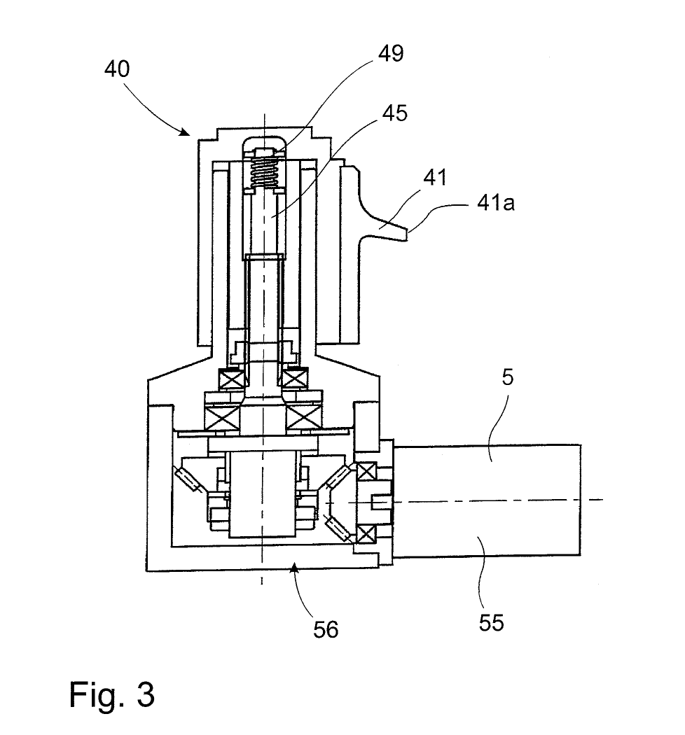

FIG. 3 shows an alternative modification for the clamping element 40. Again in the clamping element an extra electric motor 5 acting as direct drive 55 is associated acting via an angular gear 56 on the spindle 45. The clamping element 40 has a pressure-generating element 49 designed in the example as pressure spring or spring assembly. The pressure-generating element presses the clamping claw 41, 41′ in uncoupled state in the clamping position. The clamping claw 41, 41′ has additionally a nose-like clamping lug 41a that is in contact with the work piece 2a or engages in it. The clamping lug 41a faces in clamping direction angled the clamping plane.

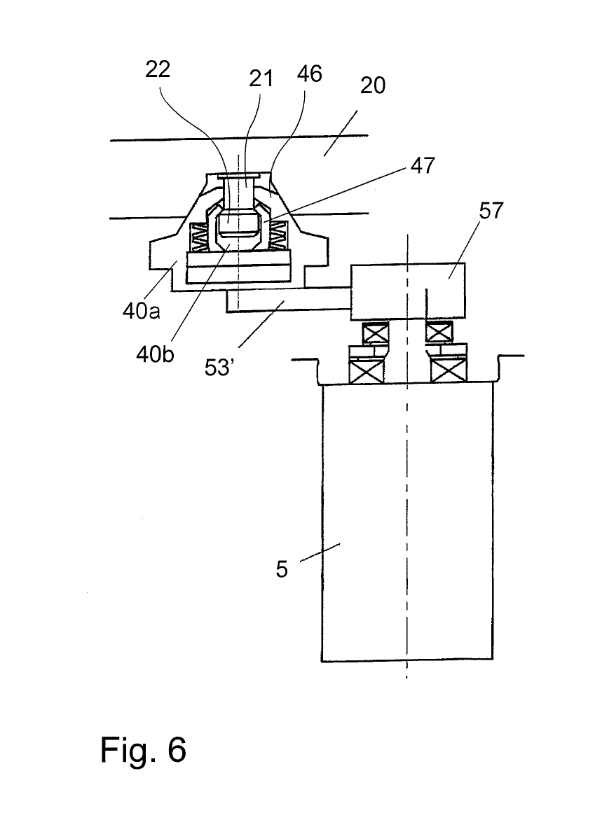

FIG. 6 shows another alternative modification of the clamping element 40a. The not shown work piece 2 is arranged on a work piece carrier 20 or a pallet 20, and exactly fixed on it. The work piece carrier 20 has on its underside at least one pin 21 projecting in the clamping element 40a or in a recess 40b.

The clamping element 40a has collet chucks 46 which grip behind the pin head 22. Operation of the collet chucks 46 is now carried out preferably hydraulically. The means 53′ for power transmission is here the hydraulic medium under corresponding working pressure; the electric motor 5 suggested according to the invention therefore acts on a hydraulic pump 57 generating an appropriate pressure level.

FIG. 5 shows in a detailed view the lathe or jaw chuck 6. As described, the suggestion according to the invention allows removing the supporting plate 42 from the work piece table 3. At the end of the motor shaft 50 opposite the motor there is the adapter fitting 51. In this the connecting piece 52 of the motor shaft of the lathe or jaw chuck 6 projects in the same way.

The lathe or jaw chuck 6 is, by the way, designed as usual, and allows a radial gripping of the work piece 2. If necessary, additional means for connecting or fastening are provided to fasten the jaw chuck 6 on the motor shaft 50 or the work piece table 3.

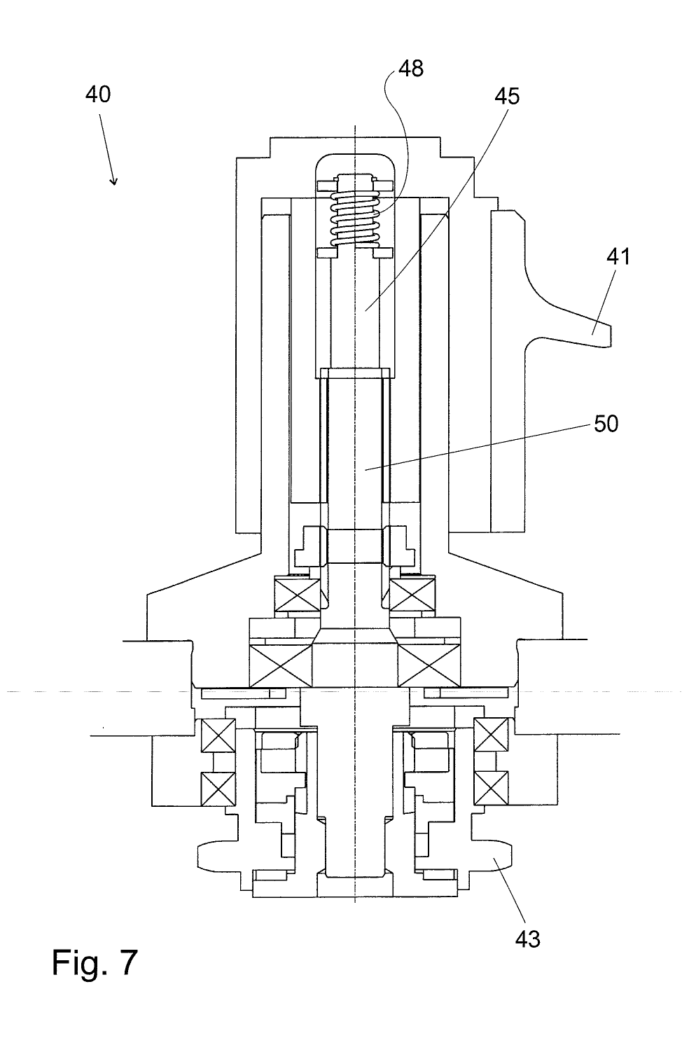

FIG. 7 shows another embodiment of the clamping element according to the invention. In contrast to the already presented modifications, here below the clamping element 40 there is a toothed wheel 43 designed as chain pinion at which, for example, a chain engages as means 53 for power transmission. All other reference numbers correspond with already presented reference numbers so that presenting them again is not necessary.

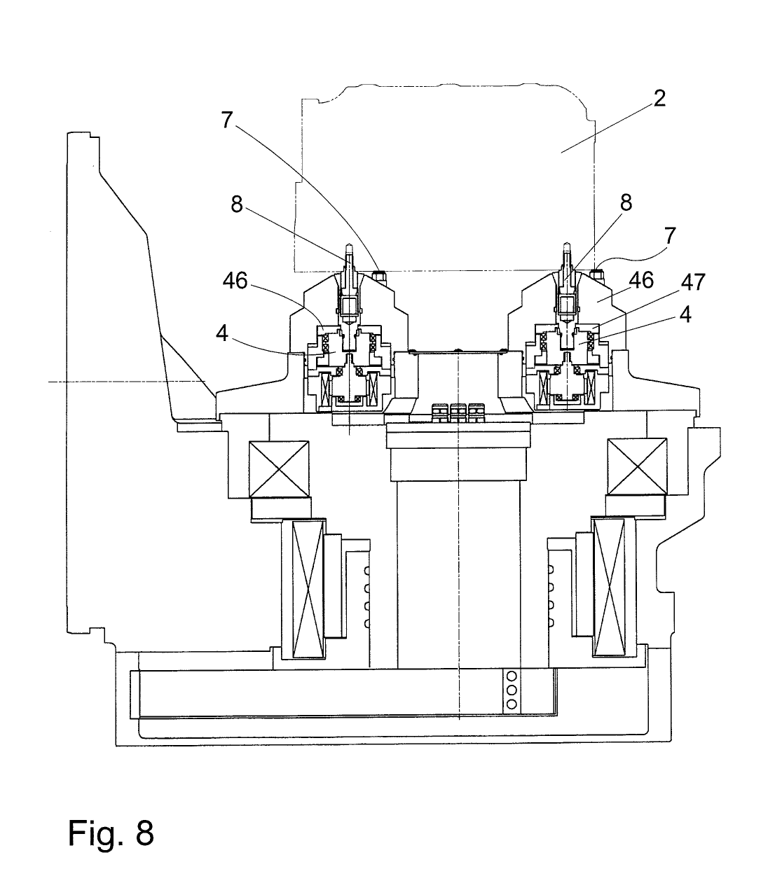

FIG. 8 shows in a side view another embodiment of a machine tool according to the invention with zero point clamping. Here only a part of the machine tool is shown that makes clear how here the clamping means are employed in interaction with a zero pint clamping. The zero point clamping device serves, as already mentioned, for exact positioning or orientation of the work piece 2 at or on the machining surface. In the presented case of FIG. 8, reference surfaces 7 are provided on the clamping elements. These reference surfaces 7 serve for making the exact positioning of the work piece or a pallet carrying the work piece easier. Because of these reference surfaces it can be determined, whether the work piece 2 is positioned exactly or not.

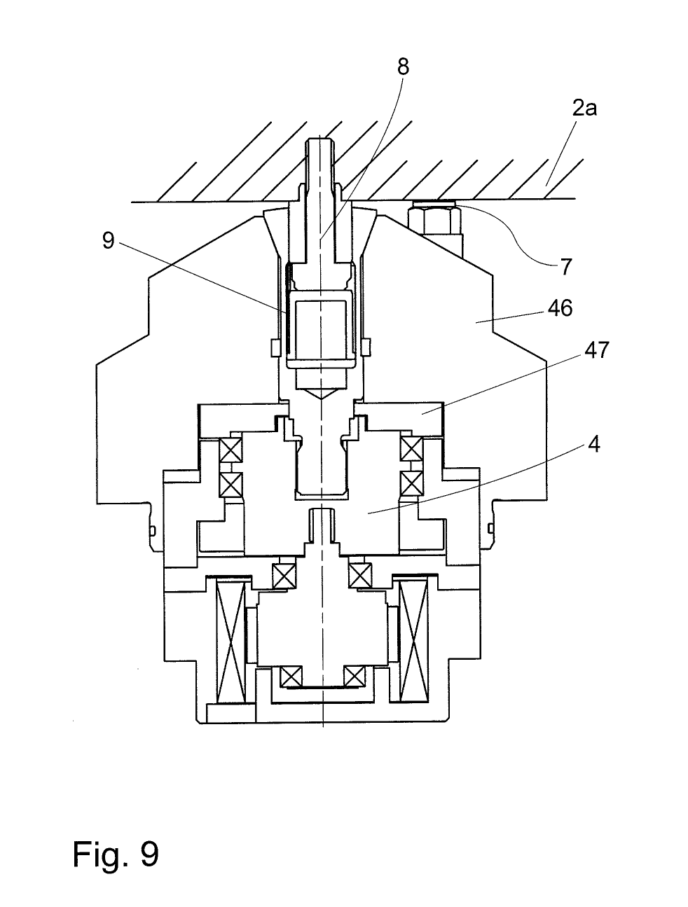

The work piece 2 has on its side facing the clamping device clamping nipples 8. These clamping nipples 8 are embraced by collet chucks 46. In the collet chucks 46 also, as described previously, clamping clasps 47 are arranged serving for an additional improvement of the clamping of the clamping nipple 8. This design allows to make the clamping process very exactly by combining here the advantages of the zero point clamping with the advantages of the electric mechanic clamping. Instead of an arrangement on the work piece 2 the clamping nipple 8 can also be arranged on a pallet 2a carrying the work piece. This pallet 2a is shown schematically in FIG. 9.

In FIG. 9 a detail of FIG. 8 is shown through which it can be seen that on the clamping nipple 8 a data carrier 9 is provided. Instead of the work piece 2 here a pallet 2a carrying the work piece is shown schematically. The data carrier 9 can be designed either as transponder or as bar code or as another means for transmitting information. This data carrier 9 contains information about the work piece 2 to be machined as well as favorably also information about the machining of the work piece so that, after clamping, the control recognizes immediately which machining has to be carried out, and initiates the appropriate control processes.

Although the invention has been described by exact examples which are illustrated in the most extensive detail, it is pointed out that this serves only for illustration and that the invention is not necessarily limited to it, as alternative embodiments and methods become clear for experts in the view of the disclosure. Accordingly, changes can be considered which can be made without departing from the contents of the described invention.

1. Machine tool for machining one or more work pieces, wherein the work piece is held indirectly or directly by a clamping device in the machine tool on or at a non-rotatable work piece table or a work piece table in particular rotatable around one axis, characterized in that the clamping device has at least one clamping element interacting indirectly or directly with the work piece, and an electric motor is provided for generating the clamping power that is in active connection with the clamping element.

2. Machine tool according to claim 1, characterized in that the machine tool has a motor shaft driven by an electric motor, an adapter fitting, a jaw or lathe chuck, a timing belt, a chain, a gear and a means for power transmission, wherein the electric motor drives the clamping element indirectly or directly, and the motor shaft has the adapter fitting for optional connection of the motor shaft with the at least one means for power transmission for the clamping element(s) or for connecting the motor shaft with the jaw or lathe chuck serving for the indirect or direct reception of the work piece for rotary grinding or turning on a lathe machining on the work piece, and/or the electric motor drives preferably as central drive several clamping elements via the at least one means for power transmission, in particular wherein as means for power transmission the timing belt and the chain, the gear or the like is provided.

3. Machine tool according to claim 1, characterized in that for each of the clamping elements one electric motor is provided for generating the clamping power.

4. Machine tool according to claim 1, characterized in that the machine tool has a control, wherein the electric motor is monitored by the control as NC-axis, wherein the control recognizes and derives, respectively, the exact location or the exact position of the clamping element because of these data, and/or the control recognizes the imprinted or entered power of the clamping element(s) because of the determined data or the determined moment.

5. Machine tool according to claim 1, characterized in that the machine tool has a link for the motor shaft and an axis of symmetry, and wherein the electric motor is arranged on the link for the motor shaft on the clamping device or the clamping element on the same axis of symmetry or parallel to it, in particular wherein the electric motor is arranged orientated angularly, preferably rectangular to the axis of symmetry of the clamping device or the clamping element.

6. Machine tool according to claim 1, characterized in that the clamping element has a free wheel, a clutch, designed preferably as sliding clutch, wherein at or in the clamping element the free wheel, the clutch, designed preferably as sliding clutch or the like is provided to limit the power to be transmitted.

7. Machine tool according to claim 1, characterized in that the clamping element has an element generating pressure, such as for example a pressure spring or a spring assembly, and at least one clamping claw with a clamping position or a initial or rest position, wherein on the clamping element the at least one clamping claw is provided, and the at least one clamping claw serves for clamping the work piece, and wherein on or in the clamping element the pressure-generating element, such as, for example, the pressure spring or the spring assembly is provided, and the pressure-generating element presses or moves in uncoupled state the clamping claw in the clamping position, and in coupled state the electric motor moves the clamping claw in its initial or rest position.

8. Machine tool according to claim 1, characterized in that the clamping element has a pull-back element, such as, for example, a tension spring and a clamping claw with a coupled or non-clamped state and an initial position, wherein on or in the clamping means the pull-back element, such as, for example, the tension spring is provided moving the clamping claw in the uncoupled or non-clamped position in the initial position.

9. Machine tool according to claim 1, characterized in that the clamping means has a clamping claw, a nose-like clamping heel, a clamping direction and a clamping plane, wherein on the clamping claw the nose-like clamping lug is provided, wherein the clamping lug is arranged in clamping direction facing the clamping plane angled, deviating 1° to 5°, preferably 2° from a parallel plane to the clamping plane, in particular wherein the clamping claw can be moved essentially rectangular to the clamping plane.

10. Machine tool according to claim 1, characterized in that the clamping element is designed as a collet chuck.

11. Machine tool according to claim 1, characterized in that the machine tool has a pallet carrying the work piece, and the machine tool or the work piece has a pin, and wherein the clamping element is designed like a truncated cone and has a mounting, wherein the pin arranged on the pallet carrying the work piece or on the work piece is introduced in the mounting for the clamping process.

12. Machine tool according to claim 1, characterized in that the clamping element is designed as collet chuck with clamping clasps and has a mounting, and the machine tool has a pallet carrying the work piece, and the machine tool or the work piece has a pin, wherein the pin is inserted in the mounting, and the mounting is embraced by the collet chuck that pushes preferably the clamping clasps in clamped state against or towards the pin, and/or wherein a pin head is formed in the pin.

13. Machine tool according to claim 1, characterized in that the machine tool has a motor shaft driven by the electric motor, an adapter fitting and at least one means for power transmission, the motor shaft has the adapter fitting for an optional connection of the motor shaft with the at least one means for power transmission, and the clamping element has a pressure-generating hydraulic pump, and the clamping element is designed as collet chuck, wherein the means for power transmission engages on the collet chuck, and preferably clamping element and/or the collet chuck are designed hydraulically acting, wherein the pressure-generating hydraulic pump is provided directly at or in the clamping element or at or in the collet chuck.

14. Machine tool according to claim 1, characterized in that the machine tool has a central hydraulic aggregate and the clamping element has a hydraulic pump, wherein at or in the clamping element the hydraulic pump is provided, and the hydraulic pump acts independently from the central hydraulic aggregate, generates the necessary contact pressure directly at or in the clamping element.

15. Machine tool according to claim 1, characterized in that the machine tool has a clamping power control, wherein the clamping power control is provided for monitoring the exact clamping of the work piece.

16. Machine tool according to claim 1, characterized in that the machine tool has a machining tool, a zero point clamping device, a machining surface, a reference surface and a pallet carrying the work piece, wherein at least one of the clamping elements is designed for receiving at least one machining tool, and/or the zero point clamping device is provided at or on the machining surface for an exact positioning or orientating the tool, preferably wherein on the clamping means or in its immediate vicinity and/or on the machining surface or the clamping surface the at least one reference surface is provided to determine or check the exact positioning of the work piece or the pallet carrying the work piece.

17. Machine tool according to claim 1, characterized in that the machine tool has a clamping nipple, a clamping surface, an identification means such as, for example, a data carrier, transponder or bar code with information about the work piece or machining of the work piece, and a separate fastening means, wherein on the work piece and/or the clamping surface a clamping nipple is provided serving for positioning and/or clamping the work piece on the clamping surface, and wherein preferably at or in the clamping nipple the identification means, such as, for example, the data carrier, transponder or bar code with information about the work piece or the machining of the work piece is provided, in particular wherein the identification means is arranged additionally or alternatively, for example, with the separate fastening means on the clamping nipple.

18. Machine tool according to claim 1, characterized in that the electric motor is designed as synchronous, asynchronous or direct current motor.

19. Machine tool according to claim 1, characterized in that the machine tool has a sensorless recognition system for the rotor position or standstill position, and the electric motor is designed as sensorless synchronous or asynchronous motor, and/or as permanent magnet excited synchronous motor, and wherein in the synchronous motor the sensorless definition system for the rotor position, in particular the sensorless recognition system for the standstill position is provided, wherein preferably the definition for the rotor position can be carried out software- or NC-controlled.
